(19) United States
(12) Patent Application Publication
(10) Pub. No.: US 2004/0010418 A1
(43) Pub. Date: Jan. 15, 2004

(54) Method and system for increasing the efficacy of a clinical trial

(76) Inventors: Marc A. Buonocore, Bridgewater, NJ (US); David M. Rettagliata, Boonton, NJ (US)

Correspondence Address: Leslie Gladstone Restaino, Esq., Brown Raysman Millstein Felder & Steiner LLP, 163 Madison Avenue, P.O. Box 1989, Morristown, NJ, 07962-1989, US

(21) Appl. No.: 10/193,945

(22) Filed: Jul. 10, 2002

(51) Int. Cl. G06F 17/60

(52) U.S. Cl. 705/2

(57) ABSTRACT

The present invention provides a method and system for increasing the efficacy of a clinical trial, whereby a plurality of clinical trial compliance messages are transmitted to a clinical trial participant so that the clinical trial participant may more closely adhere to the parameters of a clinical trial protocol.

### COPYRIGHT NOTICE

A portion of this disclosure contains material that is subject to copyright protection. The copyright owner has no objection to the facsimile reproduction by anyone of the patent disclosure, or to the patent document issuing from the patent disclosure, as it appears in the offices or records of the United States Patent and Trademark Office. All other rights associated with the copyright are reserved in their entirety.

### BACKGROUND OF THE INVENTION

A clinical trial is a carefully regimented research program that allows a clinical investigator to evaluate a new drug, medical device, or biologic (or a novel application of a known drug, medical device or biologic), in the treatment, prevention or diagnosis of a disease or condition. Specifically, a clinical trial allows for the determination of whether such a product is considered safe and effective, in light of the product's benefits relative to its risks.

There are many types of clinical trials, including: dose ranging studies, treatment trials, prevention trials, screening trials, and quality of life trials. Dose ranging studies test various doses of an agent, and compare which dosage works the best with the least side effects. In a treatment trial, a new treatment, a new combination of drugs, or a new approach to surgery or radiation therapy is evaluated for safety and efficacy. Prevention trials evaluate medicines, vitamins, vaccines, minerals or lifestyle changes in preventing the occurrence or recurrence of a disease. Screening trials test the best ways to detect certain diseases or health conditions, while quality of life trials explore ways to improve the comfort and quality of life for individuals with a disease or illness.

Typically, a clinical trial involves multiple stages, each concerned with a different aspect of testing the drug, device or biologic. Phase I studies are primarily designed to determine the effect of a new drug on a small population of healthy subjects. The drug is evaluated at different doses, and the rates and routes of absorption, metabolism and excretion are determined. Specifically, this phase is concerned with establishing the safety of a new drug, and may take several months to complete.

Drugs that pass through phase I testing for safety and efficacy evaluation in a larger population of individuals. These individuals (up to several hundred) are afflicted with the disease or condition for which the drug is being developed. These studies are often randomized (where one group of subjects will receive a placebo) and blinded (where the participants, and sometimes the investigators, are unaware whether they are receiving treatment or a placebo). Only about one-third of experimental drugs successfully complete both phase I and phase II studies, after 2-3 years of testing.

Phase III studies typically involve several thousand patients afflicted with the treated disease or illness. The results of a phase III study allow the F.D.A. or other regulatory body to determine whether the new drug offers any benefit or advantage over therapies currently on the market (i.e., evaluation of pharmacoeconomic considerations). It also helps to determine side effects or complications that may not have surfaced in smaller populations. These studies generally last for several years, and constitute the last phase before a sponsor may seek new drug approval from the Food and Drug Administration.

Finally, even after F.D.A. approval, a phase IV study may be undertaken to support marketing claims, further study side effects or to explore various off label uses.

One can see that there is a huge economic cost associated with the development, implementation and analysis of a clinical trial and the approval process of a new drug, biologic or medical device. There are numerous regulatory bodies, both institutional and governmental, that oversee the conduct of a clinical trial and require various and complex safeguards to ensure participant safety. There is often a huge infrastructure cost of implementing a clinical trial in several phases, including administrative costs, employee costs, health care costs and insurance costs. Finally, the analysis of data generated from a clinical trial, as well as the preparation of F.D.A. approval documents, such as a New Drug Application, is time intensive and expensive.

Accordingly, it is imperative that the economic and social cost of a clinical trial be minimized in such a way as to not jeopardize the safety of a clinical trial participant. One way to minimize these costs involves careful adherence to a clinical trial protocol. A clinical trial protocol is a study plan on which all clinical trials are based. A protocol describes what types of people may participate in the trial; the schedule of tests, procedures, medications, and dosages; and the length of the study.

Careful adherence to the clinical trial protocol minimizes these costs since it increases the utility and meaning of data collected in a clinical trial. When clinical trial participants follow instructions exactly, then the observed results in a clinical trial can be more closely correlated with the prescribed drug or treatment regimen. Furthermore, careful adherence to the clinical protocol protects clinical trial participants from unnecessary adverse reactions or adverse events.

There are a number of reminder systems in the art intended to increase patient compliance. By way of example, the MD2 Monitoring Service (see www.epill.com, Jun. 12, 2002) is a combination medication dispensing/reminder system that plugs directly into the user's existing telephonic landline. A central support center receives the medication schedule as reported by the patient, the patient's doctor or the patient's caregiver. A service provider physically fills medication cups in the MD2 to be dispensed at the appropriate time. At the predetermined time, the MD2 delivers a medication reminder. Pushing a button delivers the correct pills and automatically alerts the central support center that the medications have been dispensed. Patient noncompliance (i.e., failure to push the button at the appropriate time) results in the notification of a pre-designated third party by telephone. A patient's individual dispensing history can be tracked over the internet to determine patterns of compliance. Other reminder messages can be delivered to the patient according to a programmed treatment protocol (i.e., “time to change your dressing” or “time to eat lunch”). Finally, the MD2 includes a two-way communication system that automatically dials the central support center and allows direct communication with operators when needed.

U.S. Pat. No. H1,782, entitled “Prescription medication notification system”, discloses a medication notification system using a wireless paging receiver to alert a patient concerning the time or times a specific medication is to be taken. The system contemplates that a pharmacist, upon receiving a patient's prescription, or a physician, upon prescribing said medication, would transmit prescription data, dosage and medication timing data to a central paging dispatch center. This information would be stored and then transmitted to the patient in accordance with the medication timing data. The patient receiving the data would then transit, alphanumerically, a confirmation to the paging dispatch center. Additional embodiments include more extensive use of the two-way pager, whereby the patient's physician would ask detailed questions regarding the patient's health, or give detailed reminders regarding food intake, exercise and the like, and then receive from the patient, via the paging dispatch center, responses to the queries/reminders.

U.S. Pat. No. 5,950,630, entitled “System and method for improving compliance of a medical regimen”, discloses a system and method for improving compliance by a patient with a medical regimen, and generally relates to a system that checks for interactions and complications from pharmaceutical regimens. The patent describes a computer system upon which pharmaceutical data, patient data and patient prescription data is stored. A central processing unit operatively linked to the stored information is programmed to generate a patient message based on the information, generally reminding the patient to take his or her medication, together with any queries contained in the message relating to drug side effects, interactions, etc. This message is then transmitted (via a message receiving unit operatively linked to a transmission unit) to a patient's pager. A preferred embodiment describes the use of a two-way pager (or other two-way communication system) so that the patient may confirm receipt of the message and answer any questions included in the message. Compliance information is then stored and reported to the prescriber or physician.

Finally, U.S. Pat. No. 6,014,626, entitled “Patient monitoring system including speech recognition capability”, discloses a central monitoring system for monitoring drug usage by a patient, comprising (i) a means for identifying a patient who initiates the monitoring session, (ii) a means for retrieving a patient record from a database, where said patient record corresponds to the patient who initiates the drug monitoring system, (iii) a means for activating an expert system that determines questions to ask the patient relating to drug usage and side effects, (iv) a means for communicating said questions to the patient and receiving questions thereto; and (v) means for evaluating patient responses and communication health care status reports regarding the patient's drug usage to a health care provider. In an additional embodiment, the system further comprises a means for aggregating responses from a number of patients and providing the aggregated information to a drug company. Although this patent is directed to a system initiated by the patient, in one embodiment of the invention, the central monitoring system can itself call the patient if the patient has not reported in a set period of time and remind the patient of the need and benefits of taking the prescribed drug.

None of the reminder systems described above or that are currently known to the inventor in the prior art provide a means for compliance with clinical trial protocols. What is needed, therefore, is a clinical trial compliance system, that generates or transmits reminders according to a clinical trial protocol, nor do they disclose use in a clinical trial to increase clinical trial efficacy.

### SUMMARY OF THE INVENTION

In accordance with the present invention, a method for increasing the efficacy of a clinical trial is disclosed, the method comprising the transmission of a plurality of clinical trial compliance messages to a clinical trial participant, thereby affording the clinical trial participant a better opportunity to adhere to the requirements of a clinical trial protocol. Adherence to a clinical trial protocol is absolutely essential in order to accurately gauge the safety and efficacy of the product being evaluated; it also protects a clinical trial participant from any unnecessary risks associated with noncompliant behavior. Advantageously, the present invention increases the reliability of data obtained from a clinical trial, by allowing a clinical trial investigator to identify and account for non-compliant clinical trial participants and thereby correct and retain clinical trial participants as soon as deviation from a clinical trial protocol is detected.

In the method of the present invention, information is obtained regarding the clinical trial participant. A clinical trial compliance system is configured according to the general parameters of a clinical trial protocol, where the exact parameters are determined in light of the information obtained regarding the clinical trial participant. Once properly configured, the clinical trial compliance system may be activated to transmit a plurality of clinical trial compliance messages to the clinical trial participant, where the content of and intervals between the clinical trial reminder messages are determined according to the parameters of the clinical trial protocol.

In one embodiment, the clinical trial compliance system may be additionally configured to request or obtain a response from the clinical trial participant to the clinical trial compliance message. The response requested or obtained may comprise an acknowledgement of the clinical trial compliance message. Further, the clinical trial compliance system may be configured to alert the clinical trial investigator should the clinical trial participant fail to respond as directed to a clinical trial compliance message. As a result, the clinical trial investigator can seek to correct noncompliance or otherwise retain a deviating clinical trial participant in the event that an expected response was not received.

The present invention also discloses a clinical trial compliance system for increasing the efficacy of a clinical trial, wherein the clinical trial compliance system comprises a data storage unit capable of storing information regarding a clinical trial participant, a clinical trial investigator and a clinical trial protocol. A main central processing unit is operably linked to the data storage unit and comprises at least one program to store information regarding a clinical trial participant, a clinical trial investigator, and a clinical trial protocol, as well as at least one program to generate and transmit a clinical trial compliance message. The content and scheduled transmission of the clinical trial compliance message is made in accordance with the parameters of the clinical trial protocol. The clinical trial compliance system also comprises a telecommunications system operably linked to the main central processing unit, as well as a message unit operably linked to the telecommunications system, wherein the message unit allows the clinical trial participant to receive, via the telecommunications system, the clinical trial compliance message transmitted by the main central processing unit.

In one embodiment of the clinical trial compliance system, the message unit of the clinical trial participant further allows the clinical trial participant to transmit a response to the clinical trial compliance message, wherein the response is decoded and stored by the main central processing unit. Further, the main central processing unit can be programmed to contact the clinical trial investigator in the event that an expected response of a clinical trial participant is not detected, thereby allowing the clinical trial investigator to correct noncompliance or otherwise retain a deviating clinical trial participant.

Additional aspects of the present invention will be apparent in view of the illustrative figures and the detailed description, which follow.

### BRIEF DESCRIPTION OF THE FIGURES

FIG. 1 is a flowchart illustrating a method of using the clinical trial compliance system to increase the efficacy of a clinical trial in accordance with one embodiment of the present invention.

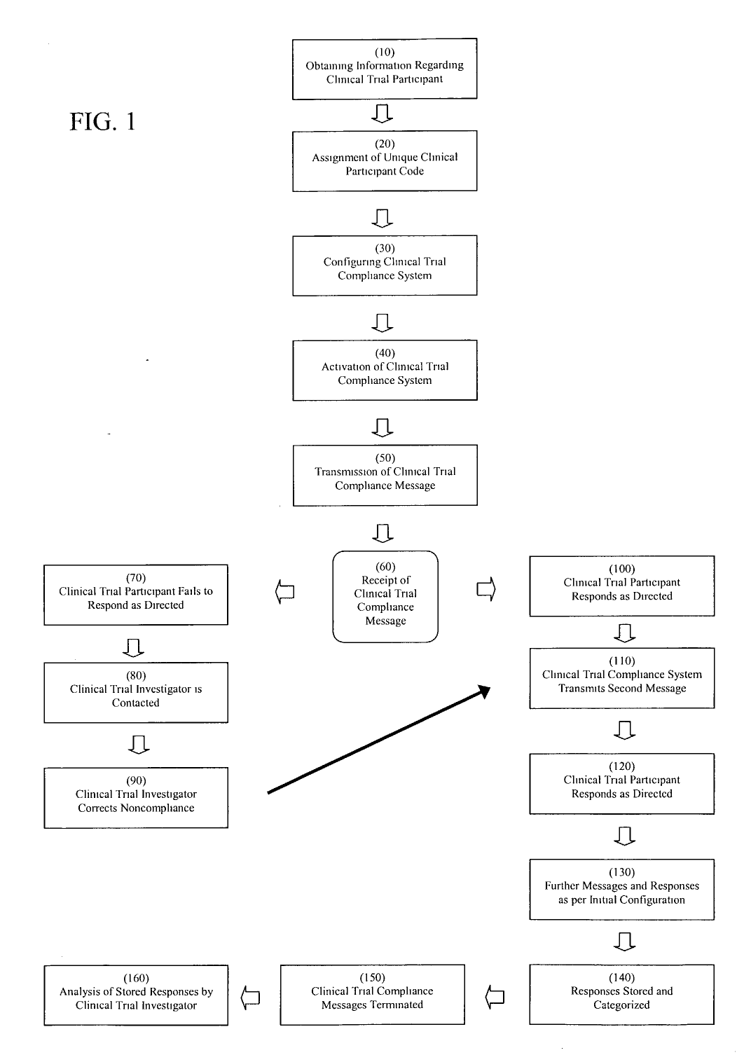

FIG. 2 illustrates a clinical trial compliance system in accordance with one embodiment of the present invention, utilizing a wireless telecommunications system.

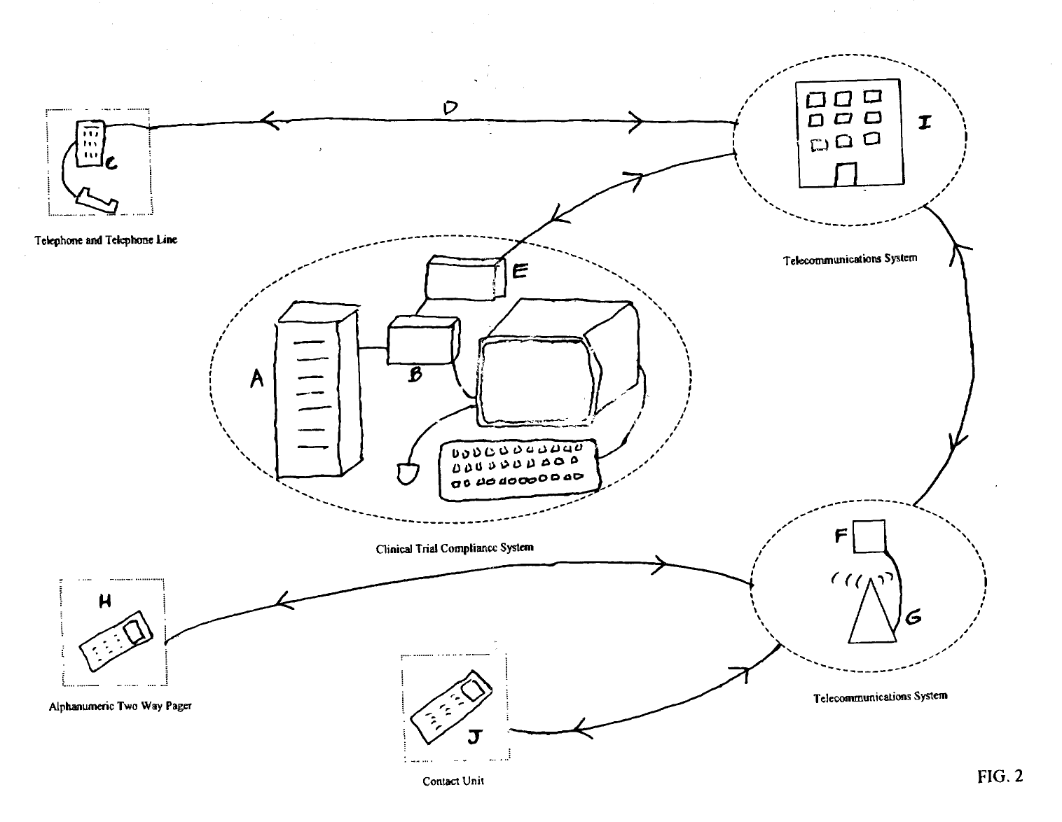

### DETAILED DESCRIPTION OF THE INVENTION

The present invention comprises a method and a system to increase the efficacy of a clinical trial. As used herein, a “clinical trial” refers to a study designed to evaluate the safety and/or efficacy of a drug, device or biologic in the treatment, prevention or diagnosis of a disease or condition in a human subject.

The method and system disclosed herein may be used with any type of clinical trial, including a dose ranging study, a treatment trial, a prevention trial, a screening trial or a quality of life trial. In the preferred embodiment of the invention, the method and system of the present invention may be used in an investigation to assess the safety and efficacy of a drug in the treatment of a disease or condition, in light of the drug's benefits relative to its risks.

A clinical trial is directed by a clinical trial investigator according to the terms of a clinical trial protocol. As used herein, a “clinical trial investigator” is the person who is ultimately responsible for administering a clinical trial according to the terms of a clinical trial protocol. The definition also includes those persons working under the supervision of a clinical trial investigator, or who are under his or her direction. Accordingly, as used herein, a clinical trial investigator may include such persons commonly referred to in the art as a certified research coordinator, a contract research organizer, a sub-investigator, a clinical research associate, a clinical research coordinator, a research nurse, or a protocol nurse, among others. A “clinical trial protocol” is a study plan upon which all clinical trials are based, and describes what types of people may participate in the trial; the schedule of tests, procedures, medications, and dosages; as well as the length of the study. A “clinical trial participant” is a human subject enrolled in a clinical trial.

The method of the present invention first comprises the step of obtaining information regarding a clinical trial participant, followed by the step of configuring a clinical trial compliance system according to the parameters of a clinical trial protocol, wherein the exact parameters are determined according, in part, by the information obtained regarding the clinical trial participant.

The information obtained regarding the clinical trial participant includes such information as is required to identify and create a file for the individual clinical trial participant, as well as such information as is required by the parameters of the clinical trial protocol, i.e., as is required to determine an individualized course of treatment. Accordingly, the information obtained may include, but is not limited to, the participant's name, address, social security number, primary contact information, secondary or alternate contact information, and next of kin contact information, as well as the participant's height, weight, age and medical history.

The information regarding the clinical trial participant is used, together with the parameters of a clinical trial protocol, to configure a clinical trial compliance system. Configuration of the clinical trial compliance system includes the generation of a schedule of clinical trial compliance messages to be transmitted to the clinical trial participant, where the content of and intervals between clinical trial reminder messages are determined according to the parameters of a clinical trial protocol. The exact content of the clinical trial compliance message may be anything intended to further the clinical trial or to monitor the condition of the clinical trial participant.

In one example, the content of the clinical trial compliance message may include instructions regarding the dosage of a drug, the manner of taking a drug, side effects of a drug or simply a reminder to take a drug. The compliance message may also constitute a request for acknowledgement that a drug has been taken, or contain a query as to any side effects experienced by the clinical trial participant or to any beneficial effect experienced by the clinical trial participant.

The clinical trial compliance message may also instruct the clinical trial participant to take any action required by the clinical trial protocol, perhaps to fill out a pain management questionnaire, or to adjust a device being used to treat the clinical trial participant, to schedule an appointment with a health care provider or to contact the clinical trial investigator. The clinical trial compliance message may simply query the general health of the clinical trial participant.

Once properly configured, the clinical trial system is then activated to transmit a plurality of clinical trial compliance messages to the clinical trial participant so that the clinical trial participant can act accordingly. In one embodiment, the clinical trial investigator activates the clinical trial compliance system, using a unique clinical trial participant code assigned to the subject clinical trial participant. The clinical trial investigator may activate the clinical trial compliance system via telephone, where the telephone is operably linked to the clinical trial compliance system, or by a computer that is part of a local area network (LAN) or wide area network (WAN), such as the Internet, where the network is operably linked to the clinical trial compliance system.

In another embodiment, the clinical trial participant activates the clinical trial compliance system, preferably by using a telephone or a wide area network, such as the Internet, operably linked to the clinical trial compliance system. Activation by the clinical trial participant is especially useful where the drug, device or biologic being studied in the clinical trial is for the treatment, diagnosis or prevention of an acute disease or condition, i.e., migraine, angina, asthma attack, anxiety attack, or the like. In both embodiments, the clinical trial compliance system is password protected, so the system cannot duplicate activation for any particular clinical trial participant.

The intervals between clinical trial reminder messages are determined according to the parameters of a clinical trial protocol. For instance, the clinical trial protocol may require that the drug being tested be administered once a day with food. In this instance, the clinical trial compliance system is configured to transmit a clinical trial compliance message to the participant at the same time each day, together with a reminder to take the subject drug with food. Any arrangement of compliance messages may be generated, i.e., a reminder message may be sent three times a day, while a query as to side effects experiences is sent twice a day. There is simply no limit to the number or combination of clinical trial compliance messages that could be generated and transmitted by the clinical trial compliance system, other than the practical limitation of diminished cooperation by the clinical trial participant.

In a preferred embodiment of the invention, the intervals between each clinical trial reminder message are calculated as a period of time from the initial activation of the clinical trial compliance system. In this manner, by way of example, the clinical trial compliance system can be configured to generate and transmit clinical trial compliance messages every hour for the first three hours following activation, then every five hours for the next 50 hours, then every 24 hours for the next 36 hours, etc., until the course of the clinical trial is completed. Such a configuration allows for greater flexibility than generation and transmission on a calendar basis (i.e., at the same time each day), and allows the clinical trial investigator to more accurately track possible adverse reactions, adverse effects and pharmacological effects associated with a drug or biologic under investigation, especially in clinical trials of short duration (i.e., clinical trials associated with the treatment, diagnosis or prevention of an acute illness or condition).

Further, clinical trial compliance messages may be sent regarding multiple drugs, devices or biologics under investigation, so that one clinical trial compliance message may be directed to a first drug, device or biologic, while another clinical trial compliance message may be directed to a different drug, device or biologic. Alternatively, the content of the clinical trial compliance messages with regard to multiple items under investigation could be combined in one clinical trial compliance message.

The clinical trial compliance messages may be transmitted by the clinical trial compliance system in such a manner as to be understandable by the human ear, such as is the case where the clinical trial compliance system comprises a voice generator or a sound board, together with the associated programs supporting use of a voice generator or sound board. In this case, the clinical trial participant may receive the clinical trial compliance message over a standard pulse or touch tone telephone according to the contact information obtained regarding the clinical trial participant. Preferably, the clinical trial compliance message would be transmitted to a cell phone carried by the clinical trial participant, so that the clinical trial participant could be contacted by the clinical trial compliance system in virtually any location accessible by a cellular network.

In an alternate embodiment of the present method, the clinical trial compliance messages may be transmitted by the clinical trial compliance system so as to be readable on an alphanumeric device carried by the clinical trial participant, such as a pager, a portable digital assistant, or a cell phone with instant message capability.

In yet another embodiment of the present method, the clinical trial compliance messages may be transmitted by the clinical trial compliance system electronically over a network, such as a wide area network (WAN) or the Internet, so that the clinical trial participant may receive the clinical trial compliance message as an e-mail or over a dedicated web page. Such an embodiment would be especially useful in longitudinal studies spanning several years, where the protocol demands periodic checks on and updates by the clinical trial participant, separated by long intervals of inactivity.

In a preferred embodiment of the invention, the method further comprises the step of requesting or obtaining a response by the clinical trial participant to a clinical trial compliance message, whereby the clinical trial compliance system includes in the clinical trial compliance message a request for response, and the clinical trial participant transmits the response to the clinical trial compliance system. The response requested by the clinical trial compliance system may simply be an acknowledgement of the clinical trial compliance message. Alternatively, the response requested might be a description of any side effects or effects experienced by the clinical trial participant, or regarding the general health of the clinical trial participant, or the results of a survey or questionnaire to be taken by the clinical trial participant.

Where the clinical trial compliance system transmits the clinical trial compliance messages to a telephone, the clinical trial participant may respond verbally where the clinical trial compliance system has been configured to decode voice signals, such as is the case where the clinical trial compliance system comprises a speech recognition board such as a discrete, multiword speech recognizer or speaker independent continuous digit recognizer. Alternatively, the clinical trial participant may respond by a touch tone telephone where the clinical trial compliance system has been configured to receive and decode dual tone multifrequency signals, such as is the case where the clinical trial compliance system comprises a modem capable of interpreting dual tone multifrequency signals and translating the signals into characters recognizable by the computer processing unit of the clinical trial compliance system.

Where the clinical trial compliance messages are received alphanumerically by a two-way pager, personal digital assistant or cell phone with instant message capability, the clinical trial participant may transmit his or her response alphanumerically to the clinical trial compliance message using these same devices.

Finally, where the clinical trial compliance messages are received electronically via e-mail, the clinical trial participant may transmit his or her response to the clinical trial compliance message via return e-mail, where the return e-mail is transmitted electronically over a wide area network or the Internet to the clinical trial compliance system.

The clinical trial participant may also transmit a response to the clinical trial compliance system requesting immediate contact with the clinical trial investigator, whereby the clinical trial compliance system has been configured to contact the clinical trial investigator upon the receipt of such a message.

In an additional and preferred embodiment of the present invention, the method further comprises the step of attempting to reach the clinical trial participant upon the failure of the clinical trial participant to respond as directed to the clinical trial compliance message. In one instance, a preset interval of time may pass from an unanswered clinical trial compliance message before a clinical trial compliance message is retransmitted to the clinical trial participant. In another embodiment, the clinical trial compliance message might be sent to an alternate contact number provided by the clinical trial participant, either immediately following the failure of the clinical trial participant to respond to a clinical trial compliance message, or after one or more attempts to retransmit the clinical trial compliance message to the original contact number.

Preferably, the method of the present invention further comprises the step of contacting the clinical trial investigator either upon the failure of the clinical trial participant to respond as directed to a clinical trial compliance message or in the event the clinical trial participant sends a response indicating noncompliance with the clinical trial protocol, so that the clinical trial investigator can attempt to retain or to correct deviation by a clinical trial participant.

Finally, the method of the present invention further comprises the step of storing a clinical trial participant's response to a clinical trial compliance message, so that the stored responses may be accessed and analyzed by the clinical trial investigator during or at the conclusion of the clinical trial. Such an analysis of the stored responses might include, by way of example, a comparison of efficacy or safety of a drug with the rate of compliance by a group of clinical trial participants in a clinical trial, or it might include a comparison of efficacy or safety of a drug with the efficacy or safety of a different drug.

Also disclosed herein is a clinical trial compliance system for increasing the efficacy of a clinical trial. The clinical trial compliance system of the present invention comprises a data storage unit capable of storing information regarding a clinical trial participant, a clinical trial investigator and a clinical trial protocol, as well as a main central processing unit operably linked to the data storage unit, such as might be found in a conventional personal computer or in other types of computer system configurations. The main central processing unit is programmed to perform a number of functions, including (i) store information regarding a clinical trial participant, (ii) store information regarding a clinical trial investigator, (iii) store information regarding a clinical trial protocol, (iv) generate a clinical trial compliance message according to the parameters of the clinical trial protocol, and (v) transmit the clinical trial compliance message according to a schedule determined by the parameters of the clinical trial protocol.

A telecommunications system is operably linked to the main central processing unit for the transmission of clinical trial compliance messages from the main central processing unit to the message unit of a clinical trial participant. In one embodiment using wireless telecommunication technology, the telecommunications system comprises a receiving unit operably linked to the main central processing unit to receive the clinical trial compliance message from the main central processing unit, as well as a transmitting unit operably linked to the receiving unit, whereby the transmitting unit transmits the clinical trial compliance message to the message unit of the clinical trial participant. In such an embodiment, the message unit of the clinical trial participant might be a wireless alphanumeric device, such as a pager, a personal digital assistant, or a cell phone with instant message capability.

In an alternate embodiment, the telecommunications system comprises a telephone line operably linked to the main central processing unit by a modem. In such an embodiment, the message unit of the clinical trial participant might be a touchtone phone or a pulse telephone that is operably connected to the telecommunications system via the telephone line. Accordingly, the main central processing unit may further comprise means for generating and transmitting the clinical trial compliance message in a voice understandable to humans, so that the clinical trial compliance message may be received aurally over a touchtone or pulse telephone. Such means might include a voice synthesizer chip supported by appropriate software and interfaces to allow text-to-speech conversion.

Alternatively, the message unit of the clinical trial participant might be a peripheral central processing unit operably linked to the main central operating unit via a wide area network, such as the Internet. In such a case, the clinical trial compliance message is transmitted electronically via the telecommunications system so that the peripheral central processing unit receives the clinical trial compliance message as an e-mail.

In a preferred embodiment of the clinical trial compliance system, the message unit of the clinical trial participant further allows the clinical trial participant to transmit a response to the clinical trial compliance message. In this case, the central processing unit further comprises means to decode and store any responses received from a clinical trial participant. The transmitting message unit of the clinical trial participant might be an alphanumeric device, such as a two-way pager, a personal digital assistant, or a cell phone. Alternatively, the transmitting message unit of the clinical trial participant might be a peripheral central processing unit operably linked to the main central operating unit via a wide area network, such as the Internet, where the peripheral central processing unit is capable of transmitting a response to a clinical trial compliance message as an e-mail.

Alternatively, where the main central processing unit further comprises a speech recognition board or speech recognition integrated circuit, the message unit of the clinical trial participant may be a pulse telephone, so that responses may be orally delivered by the clinical trial participant and decoded and stored by the main central processing unit. Where the main central processing unit further comprises a modem capable of interpreting dual tone multifrequency signals, the message unit of the clinical trial participant might be a touch tone telephone, so that responses may be delivered by pressing the appropriate number associated with a menu of responses.

In a preferred clinical trial compliance system, the main central processing unit further comprises at least one program to take a specific action where the main central processing unit does not detect an expected response of the clinical trial participant to a clinical trial compliance message. In one embodiment, the clinical trial compliance system might attempt to reach the clinical trial participant at a predetermined contact number. In another embodiment, the clinical trial compliance system might wait a preset interval of time from an initial failure to detect an expected response before retransmitting the clinical trial compliance message to the message unit of the clinical trial participant. Preferably, where an expected response is not detected, the clinical trial compliance system will contact the clinical trial investigator.

Accordingly, a clinical trial compliance system of the present invention preferably further comprises a contact unit capable of receiving messages transmitted by the main central processing unit, so that the clinical trial investigator may be notified of noncompliance by a clinical trial participant. Specifically, where the clinical trial participant fails to respond as directed to the clinical trial compliance message, the main central processing unit is programmed to transmit a message to the clinical trial investigator notifying him or her of possible noncompliance by the clinical trial participant. This affords the clinical trial investigator an opportunity to correct noncompliance by the clinical trial participant, and thereby retain the clinical trial participant in the study. The contact unit of the clinical trial investigator may be a two-way pager, personal digital assistant, cell phone, standard touchtone or pulse telephone, or a peripheral central processing unit operably linked to the main central operating unit via a network.

### EXAMPLE

In the example described herein, a clinical trial is conducted to investigate the effect of a drug on migraine. First, the clinical trial investigator obtains information regarding the clinical trial participant, including the participant's name, age, gender, weight, height and medical history (10). This information is entered and stored in a database (A) operably linked to the main central processing unit (B). A unique clinical trial participant code is assigned to the clinical trial participant (20) and a clinical trial compliance system is configured for that particular clinical trial participant according to the parameters of a clinical trial protocol, with the exact parameters to be determined according to the information obtained from the clinical trial participant (30). By way of example, the clinical trial protocol might call for a drug to be taken per ora, at the first sign of a migraine attack, in a dosage equivalent to 5 mg/kg of body weight. Using the parameters and the information obtained from the clinical trial participant, the clinical investigator determines the exact dosage given to the clinical trial participant, which is reflected in the content of the initial clinical trial compliance message. The content of subsequent clinical trial compliance messages is also determined. Further, a schedule of clinical trial compliance messages is determined so that the intervals between each clinical trial reminder message are calculated as a period of time from the initial activation of the clinical trial compliance system, i.e., the first clinical trial compliance message is transmitted immediately following activation of the system, then clinical trial compliance messages are transmitted every 30 minutes for a period of two hours, and then every hour for a period of 2 hours.

Next, the clinical trial compliance system is activated (40), in this case by the clinical trial participant, who has been instructed to activate the system as soon as she begins to experience symptoms of migraine. She accesses the clinical trial compliance system by a telephone (C) operably linked to the main central processing unit by a telephone line (D), and activates the system by punching in her unique clinical trial participant code. The main central processing unit comprises a modem capable of interpreting dual tone multifrequency signals (E), so that the modem interprets the dual tone multifrequency signals generated by the touchtone phone and decodes these signals in a manner to be understood and acted upon by the main central processing unit. Once activated, the clinical trial reminder system is secured by password protection, and cannot be activated again for that clinical trial participant until reset by the clinical trial investigator.

Immediately following activation, the clinical trial compliance system transmits a clinical trial compliance message according to its earlier configuration for that clinical trial participant (50). The clinical trial compliance message is transmitted from the main central processing unit to a receiving unit (F) operably linked to the main central processing unit. The message is then transmitted to a transmitting unit (G) operably linked to the receiving unit, which then transmits the clinical trial compliance message to an alphanumeric two-way pager (H) carried by the clinical trial participant. The clinical trial participant receives the clinical trial compliance message as a text message on her alphanumeric two-way pager (60). The clinical trial compliance message instructs the clinical trial participant to take 225 mg of the investigated drug, and to confirm taking the drug by sending a response to the clinical trial compliance system via her two-way pager device. The clinical trial participant, following instructions, takes the drug and confirms her compliance by pressing a button on her two-way pager, which then transmits her response to the clinical trial compliance system (70) via a telecommunications system (I). Should the clinical trial participant fail to respond to the clinical trial compliance system within a predetermined amount of time (80), the clinical trial compliance system transmits a noncompliance message to a receiving unit (F) operably linked to the main central processing unit. The noncompliance message is then transmitted to a transmitting unit (G) operably linked to the receiving unit, which then transmits the noncompliance message to a contact unit (J) carried by the clinical trial investigator. The clinical trial investigator, upon receipt of the noncompliance message, then attempts to contact the clinical trial participant (100) in order to correct noncompliance and retain her for the clinical trial.

In the event the clinical trial participant fails to respond as directed to the clinical trial compliance message, the clinical trial compliance system, according to its original configuration, transmits a second clinical trial compliance message 30 minutes following activation of the clinical trial compliance system (110). The second clinical trial compliance message requests that the clinical trial participant rate her relief of a number migraine symptoms from 1-10, with 1 being no relief and 10 being total relief, i.e., relief from pain, relief from nausea, relief from light sensitivity, relief from vision disturbance, etc. The clinical trial participant then responds as directed to the clinical trial compliance message (120) using the alphanumeric function of her two-way pager to rate her symptom relief (1, 1, 3, 7, etc.).

According to its original configuration, assuming compliance by the clinical trial participant, the clinical trial compliance system continues to send the predetermined clinical trial compliance messages at every 30 minute interval for the first two hours following activation, then a message at the third and fourth hour following activation, each time asking the clinical trial participant to rate her relief of a number of migraine symptoms (130). The clinical trial compliance system stores and categorizes all of the responses of the clinical trial participant (140), so that they are available to the clinical trial investigator for later analysis. Following transmission of the entire schedule of clinical trial compliance messages, the clinical trial compliance system terminates the application to the clinical trial participant, and the system is reset for reactivation (150). The clinical trial investigator can then access the stored and categorized responses of the clinical trial participant in order to analyze the investigated drug's efficacy in comparison with the efficacy of a standard drug used to treat migraine (160).

While the foregoing invention has been described in some detail for purposes of clarity and understanding, it will be appreciated by one skilled in the art, from a reading of the disclosure, that various changes in form and detail can be made without departing from the true scope of the invention in the appended claims.

What is claimed is:

1. A method for increasing the efficacy of a clinical trial, the method comprising the steps of:
(a) obtaining information regarding a clinical trial participant;
(b) configuring a clinical trial compliance system according to the parameters of a clinical trial protocol and information obtained regarding the clinical trial participant;
(c) activating the clinical trial compliance system; and
(d) transmitting a plurality of clinical trial compliance messages to the clinical trial participant,
whereby a clinical trial investigator obtains information regarding a clinical trial participant, a clinical trial compliance system is configured according to the parameters of a clinical trial protocol and the information obtained regarding the clinical trial participant, the clinical trial compliance system is activated to transmit a plurality of clinical trial compliance reminders to the clinical trial participant, and a plurality of clinical trial compliance messages is transmitted to the clinical trial participant by the clinical trial compliance system.

2. The method of claim 1, wherein the clinical trial is a dose ranging study.

3. The method of claim 1, wherein the clinical trial is a treatment trial.

4. The method of claim 1, wherein the clinical trial is a prevention trial.

5. The method of claim 1, wherein the clinical trial is a screening trial.

6. The method of claim 1, wherein the clinical trial is a quality of life trial.

7. The method of claim 1, wherein the information is selected from the group consisting of name, address, social security number, contact information, alternate contact information, height, weight, age, medical history, and next of kin.

8. The method of claim 1, further comprising the step of assigning to the clinical trial participant a unique clinical trial participant code.

9. The method of claim 1, wherein the clinical trial compliance system is configured to generate a schedule of clinical trial compliance messages to be transmitted to the clinical trial participant, where the content of and intervals between clinical trial compliance messages are determined according to the parameters of a clinical trial protocol.

10. The method of claim 9, wherein the content of the clinical trial reminder message is selected from the group consisting of instructions regarding the dosage of a drug, instructions regarding the manner of taking a drug, instructions regarding action required by the clinical trial protocol, instructions regarding side effects of a drug, a reminder to take a drug, a request for acknowledgment that a drug has been taken, a request for acknowledgement that an action required by the clinical trial protocol has been taken, a query as to any side effects experienced by the clinical trial participant, a query as to any effect experienced by the clinical trial participant, a query as to health of clinical trial participant, a request to schedule an appointment with a health care provider, and a request to contact the clinical trial investigator.

11. The method of claim 9, wherein the intervals between each clinical trial reminder message are calculated as a period of time from the initial activation of the clinical trial compliance system.

12. The method of claim 1, further comprising the step of requesting or obtaining a response by the clinical trial participant to the clinical trial compliance message.

13. The method according to claim 12, wherein the response requested or obtained by the clinical trial participant comprises an acknowledgement of the clinical trial compliance message.

14. The method of claim 12, further comprising the step of attempting to reach the clinical trial participant upon the failure of the clinical trial participant to respond to the clinical trial compliance message.

15. The method of claim 12, further comprising the step of waiting a preset interval of time from an unanswered clinical trial compliance message and then retransmitting the clinical trial compliance message to the clinical trial participant.

16. The method of claim 12, further comprising the step of contacting the clinical trial investigator upon the failure of the clinical trial participant to respond as directed to a clinical trial compliance message.

17. The method of claim 16, further comprising the step of attempting to retain a clinical trial participant upon the failure of the clinical trial participant to respond as directed to a clinical trial compliance message.

18. The method of claim 12, further comprising the step of storing a clinical trial participant's response to a clinical trial compliance message.

19. The method of claim 18, further comprising the step of analyzing the stored responses of at least one clinical trial participant to clinical trial compliance messages.

20. The method of claim 19, wherein the analysis of the stored responses includes a comparison of efficacy or safety of a drug with the rate of compliance by a group of clinical trial participants in a clinical trial.

21. The method of claim 19, wherein the analysis of the stored responses includes a comparison of efficacy or safety of a drug with the efficacy or safety of a different drug.

22. The method of claim 1, whereby the clinical trial compliance system is activated by a clinical trial investigator using a unique clinical trial participant identification code.

23. The method of claim 22, whereby the clinical trial investigator activates the clinical trial compliance system using one of a two-way pager.

24. The method of claim 22, whereby the clinical trial investigator activates the clinical trial compliance system using a telephone.

25. The method of claim 22, whereby the clinical trial investigator activates the clinical trial compliance system via the internet.

26. The method of claim 22, whereby the clinical trial investigator activates the clinical trial compliance system via a local area network.

27. The method of claim 22, whereby the clinical trial investigator activates the clinical trial compliance system using a personal digital assistant.

28. The method of claim 1, whereby the clinical trial compliance system is activated by a clinical trial participant using a unique clinical trial participant identification code.

29. The method of claim 28, whereby the clinical trial participant activates the clinical trial compliance system using a two-way pager.

30. The method of claim 28, whereby the clinical trial participant activates the clinical trial compliance system using a touchtone telephone.

31. The method of claim 28, whereby the clinical trial participant activates the clinical trial compliance system via the internet.

32. The method of claim 28, whereby the clinical trial participant activates the clinical trial compliance system using a personal digital assistant.

33. A method for increasing the efficacy of a clinical trial, the method comprising the steps of:
(a) obtaining information regarding a clinical trial participant;
(b) configuring a clinical trial compliance system according to the parameters of a clinical trial protocol and information obtained regarding the clinical trial participant;
(c) activating the clinical trial compliance system;
(d) transmitting a plurality of clinical trial compliance messages to the clinical trial participant;
(e) requesting or obtaining a response of the clinical trial participant to the clinical trial compliance message;
(f) storing a clinical trial participant's response to a clinical trial compliance message; and
(g) attempting to retain a clinical trial participant upon the failure of the clinical trial participant to respond as directed to a clinical trial compliance message,
whereby a clinical trial investigator obtains information regarding a clinical trial participant,
a clinical trial compliance system is configured to generate a schedule of clinical trial reminder messages to be transmitted to the clinical trial participant, where the content of and intervals between clinical trial reminder messages are determined according to the parameters of a clinical trial protocol and the information obtained regarding the clinical trial participant,
the clinical trial compliance system is activated to transmit a plurality of clinical trial compliance reminders to the clinical trial participant,
a plurality of clinical trial compliance messages is transmitted to the clinical trial participant by the clinical trial compliance system,
the clinical trial participant is requested to respond to the clinical trial compliance message or a response is obtained by a clinical trial participant to the clinical trial compliance message,
a response by the clinical trial participant to a clinical trial compliance message is stored for later analysis, and
an attempt is made by the clinical investigator to retain a clinical trial participant upon the failure of the clinical trial participant to respond as directed to a clinical trial compliance message.

34. A clinical trial compliance system for increasing the efficacy of a clinical trial, comprising:
(a) a data storage unit capable of storing information regarding a clinical trial participant, a clinical trial investigator and a clinical trial protocol;
(b) a main central processing unit operably linked to the data storage unit, wherein the main central processing unit comprises at least one program to (i) store information regarding a clinical trial participant, (ii) store information regarding a clinical trial investigator, (iii) store information regarding a clinical trial protocol, (iv) generate a clinical trial compliance message according to the parameters of the clinical trial protocol, and (v) transmit the clinical trial compliance message according to a schedule determined by the parameters of the clinical trial protocol;
(c) a telecommunications system operably linked to the main central processing unit, and
(d) a message unit operably linked to the telecommunications system, wherein the message unit allows the clinical trial participant to receive clinical trial compliance messages transmitted by the main central processing unit.

35. The clinical trial compliance system of claim 34, wherein the telecommunications system comprises
(a) a receiving unit operably linked to the main central processing unit to receive the clinical trial compliance message from the main central processing unit, and
(b) a transmitting unit operably linked to the receiving unit, whereby the transmitting unit transmits the clinical trial compliance message to the message unit of the clinical trial participant.

36. The clinical trial compliance system of claim 35, wherein the message unit of the clinical trial participant is an alphanumeric device.

37. The clinical trial compliance system of claim 36, wherein the alphanumeric device is a pager, personal digital assistant, or cell phone.

38. The clinical trial compliance system of claim 34, wherein the telecommunications system comprises a telephone line operably linked to the main central processing unit by a modem, and the main central processing unit further comprises means for generating and transmitting the clinical trial compliance message in a voice understandable to humans.

39. The clinical trial compliance system of claim 38, wherein the message unit of the clinical trial participant is a touchtone telephone, a pulse telephone or a cell phone.

40. The clinical trial compliance system of claim 34, wherein the message unit of the clinical trial participant is a peripheral central processing unit operably linked to the main central operating unit via a network, and where the peripheral central processing unit is capable of receiving the clinical trial compliance message as an e-mail.

41. The clinical trial compliance system of claim 34, wherein the message unit of the clinical trial participant further allows the clinical trial participant to transmit a response to the clinical trial compliance message, and wherein the central processing unit further comprises means to decode and store any responses from a clinical trial participant.

42. The clinical trial compliance system of claim 41, wherein the message unit of the clinical trial participant is an alphanumeric device.

43. The clinical trial compliance system of claim 42, wherein the alphanumeric device is a two-way pager, a personal digital assistant, or a cell phone.

44. The clinical trial compliance system of claim 41, wherein the message unit of the clinical trial participant is a peripheral central processing unit operably linked to the main central operating unit via a network, and where the peripheral central processing unit is capable of transmitting a response to a clinical trial compliance message as an e-mail.

45. The clinical trial compliance system of claim 41, wherein the message unit of the clinical trial participant is a pulse telephone, and where the main central processing unit comprises a speech recognition board operably linked to speech recognition software.

46. The clinical trial compliance system of claim 41, wherein the message unit of the clinical trial participant is a touch tone telephone, and where the main central processing unit comprises a modem and associated programming capable of interpreting dual tone multifrequency signals.

47. The clinical trial compliance system of claim 41, wherein the clinical trial compliance system further comprises a contact unit which is capable of receiving messages transmitted by the main central processing unit.

48. The clinical trial compliance system of claim 47, wherein the contact unit is a two-way pager, a personal digital assistant, or a cell phone.

49. The clinical trial compliance system of claim 47, wherein the contact unit is a peripheral central processing unit operably linked to the main central operating unit via a network.

50. The clinical trial compliance system of claim 41, wherein the main central processing unit further comprises at least one program to contact the clinical trial investigator where the main central processing unit does not detect an expected response of the clinical trial participant to a clinical trial compliance message.

51. The clinical trial compliance system of claim 41, wherein the main central processing unit further comprises at least one program to attempt reaching the clinical trial participant at a predetermined contact number where the main central processing unit does not detect an expected response of the clinical trial participant to a clinical trial compliance message.

52. The clinical trial compliance system of claim 41, wherein the main central processing unit further comprises at least one program to wait a preset interval of time from a failure to detect an expected response by a clinical trial participant to a clinical trial compliance message before retransmitting the clinical trial compliance message to message unit of the clinical trial participant.

53. A clinical trial compliance system for increasing the efficacy of a clinical trial, comprising:
(a) a data storage unit capable of storing information regarding a clinical trial participant, a clinical trial investigator and a clinical trial protocol;
(b) a main central processing unit operably linked to the data storage unit, wherein the first central processing unit comprises at least one program to (i) store information regarding a clinical trial participant, (ii) store information regarding a clinical trial investigator, (iii) store information regarding a clinical trial protocol, (iv) generate a clinical trial compliance message according to the parameters of the clinical trial protocol, (v) transmit the clinical trial compliance message according to a schedule determined by the parameters of the clinical trial protocol, and (vi) decode and store responses by the clinical trial participant to a clinical trial compliance message;
(c) a telecommunications system operably linked to the main central processing unit;
(d) a message unit operably connected to the telecommunications system, wherein the message unit allows the clinical trial participant to both receive clinical trial compliance messages transmitted by the main central processing unit and to transmit responses to the clinical trial compliance messages, where the responses to the clinical trial compliance messages are transmitted via the telecommunications system to the main central processing unit; and
(e) a contact unit of the clinical trial investigator operably connected to the telecommunications system, wherein the contact unit allows the clinical trial investigator to receive messages from the main central processing unit in the event that the clinical trial participant fails to respond as directed to a clinical trial compliance message.
